(19) United States
(12) Patent Application Publication
(10) Pub. No.: US 2011/0265514 A1
(43) Pub. Date: Nov. 3, 2011

(54) METHOD OF CUTTING DIAMONDS

(76) Inventor: Gregory C. Fakier, Houma, LA (US)

(21) Appl. No.: 13/142,943

(22) PCT Filed: Dec. 28, 2009
(86) PCT No.: PCT/US09/69605

§ 371 Date: Jun. 30, 2011

Related U.S. Application Data
(60) Provisional application No. 61/141,361, filed on Dec. 30, 2008.

(51) Int. Cl. A44C 17/00; A44C 27/00; A44C 15/00; A44C 5/00; A44C 7/00; B28D 5/00; A44C 9/00

(52) U.S. Cl. 63/12; 125/30.01; 63/32; 63/15; 63/3

(57) ABSTRACT

In a method of taking a star facet of a diamond and extending its length to the girdle (the outside perimeter) of the diamond, a shield style (obelisk-shaped) facet is produced in rounds and fancy cut diamonds, and on square and off squares it remains a three-sided facet but is made larger and longer. The facet becomes larger than it was previously. It becomes a five-sided facet when it was a three before (or a much larger three-sided facet on squares and off squares). The reason it becomes five-sided is because when the facet is extended it collides with the bezel and both upper girdle facets as it extends to the girdle on rounds and fancy cut diamonds. The new facet on square and off square becomes longer and larger but remains three-sided. When the new star facet of rounds, fancy, square and off square diamonds collide with the others it produces a new larger facet and makes an exchange of positions of the previous largest facet which is true of all rounds, fancy, square and off square. This new facet has a different angle from the previous largest facet. Because of the adjustment it appears a little different because the world is used to the standard cuts. The new cut produces new angles for the largest facet and produces a very appealing display of light performance.

### CROSS-REFERENCE TO RELATED APPLICATIONS

This application claims priority of my U.S. Provisional Patent Application No. 61/141,361, filed 30 Dec. 2008, and incorporated herein by reference.

My co-pending U.S. Design Pat. application Ser. No. 29/322,096, filed 29 Jul. 2008, is incorporated herein by reference.

This is not a continuation or a continuation-in-part of any patent application.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

There are many different cuts for diamonds in the prior art.

My U.S. Pat. No. D0558636 discloses five-sided facets on the crown of a diamond. The five-sided facets do not extend from the table to the girdle.

U.S. Pat. No. 7,225,642 has five-sided facets that appear to extend from table to girdle. The base of the pentagon is on the girdle. See facets 24 in FIGS. 1, 3, and 4. Each facet 24 is a five-sided pentagon, reaching from table to girdle. It is a squat obelisk shape. There are eight upper girdle facets 24. The diamond is an octagon in plan.

Pentagon-shaped facets appearing to extend from table to girdle can be seen at http://chestofbooks.com/home-improvement/workshop/Turning-Mechanical/Cutting-Facets-Part-4.html (see picture 1158—shown in CuttingFacets.pdf attached to the IDS in the present patent application). The diamond has five-sided pentagon-shaped facets on the crown of the diamond, with the base of the pentagon at the girdle. There are also pentagon-shaped facets on the lower portion of the diamond (below the girdle), with the base of these at the very bottom of the diamond.

Published patent application US2008/0034793 A1, FIG. 11, shows six obelisk-shaped facets that extend from the table to the girdle. FIG. 3B shows eight pentagon-shaped facets that extend from the table to the girdle, and the base of the pentagon is at the table. FIG. 11 of published patent application US2008/0034793 A1 is an intermediate diamond, not the finished product that will be sold to be used in a piece of jewelry.

Published patent application US20090056374 A1 has pentagon-shaped facets 124 in FIG. 2B that reach boundary of crown (but they do not touch the table).

### BRIEF SUMMARY OF THE INVENTION

The present invention includes a method of altering an already-cut diamond to adjust some of its facets to provide a new diamond having larger flashes of light. The diamond of the present invention can be re-cut from a traditional, conventional and any cut diamond “TCA” which possesses a star facet on the final product (the final product being the completed work as intended to be used by a jeweler to set in a setting).

The benefits of the adjustment made to the diamond cut are a simple adjustment of one group of facets on a standard diamond:

1) produces a new attractive looking diamond;

2) produces a larger facet in a different position;

3) produces a different degree and angle for that new facet to give off light and receive light;

4) has a pleasing look in relationship to the bottom facets of the diamond;

5) can be done to any diamond that possesses a star facet. A star facet is present in typical round, marquise, pear, oval and heart-shaped diamonds of traditional cut round and fancy cut diamonds. Square and off-square diamonds also possess star facets.

The action is to take the star facet of a diamond and extend its length to the girdle (the outside perimeter) of the diamond. In doing so, a unique shield style facet is produced in round and fancy diamonds. The facet becomes larger than it was previously. It becomes a five-sided facet when it was a three-sided facet before. The reason it becomes five-sided is because when the facet is extended it collides with the bezel and both upper girdle facets as it extends to the girdle. When the new facet collides with the others it produces the larger facet and makes an exchange of positions of the previous largest facet (bezel).

This new facet has a different angle from the bezel facet. So, the largest facet makes a move and changes the angles compared to what was there before. Because of the adjustment it appears a little different because the world is used to the standard cuts. The new cut produces new angles for the largest facet and produces a very appealing display of light performance.

The present invention also includes diamonds which are produced by the method. The present invention also includes diamonds which are similar or identical to diamonds produced by the method, but which are directly cut from rough diamonds.

Preferably, the upper facets include at least four five-sided facets in round and fancy-cut diamonds.

Preferably, the existing cut diamond is one which was cut at least six months (more preferably at least one year, even more preferably at least two years, and most preferably at least three years) before being re-cut (in this manner one is recycling diamonds, taking some that do not sell well and re-cutting them to be more attractive to some customers). Thus, inventory that would otherwise languish because the cuts may be out of style might get new life and move out of jewelry stores.

The methods of the present invention can be used to cut or re-cut diamonds of any weight. However, if the diamonds are too little and there may be no visual difference to the naked eye of a traditionally cut diamond and a diamond cut or re-cut using a method of the present invention. Preferably a diamond cut or re-cut using a method of the present invention has a weight of at least 0.10 carats, more preferably at least 0.20 carats (⅕ of a carat), even more preferably at least 0.25 carats, even more preferably at least 0.50, even more preferably at least 0.75, and even more preferably at least 1.00. For example, a typical jewelry store might have cut diamonds sitting around unsold for a period of six months to three years or more in sizes of 0.40-3 carats. These unsold cut diamonds could advantageously be re-cut using a method of the present invention to give them a look which some customers might find to be more attractive.

The new diamond of the present invention is preferably used as part of a piece of jewelry. The jewelry can be, for example, a ring, earrings, a bracelet, or a necklace.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a top view of a TCA round diamond showing the original cut facets;

FIG. 2 is a top view of a round diamond of the present invention showing the new facets;

FIG. 3 is a side view of a round diamond of the present invention showing the new facets;

FIG. 4 is a top view of an TCA oval diamond showing the original cut facets;

FIG. 5 is a top view of an oval diamond of the present invention showing the new facets;

FIG. 6 is a side view of an oval diamond of the present invention showing the new facets;

FIG. 7 is a top view of a TCA cushion diamond showing the original cut facets;

FIG. 8 is a top view of a cushion diamond of the present invention showing the new facets;

FIG. 9 is a side view of a cushion diamond of the present invention showing the new facets;

FIG. 10 is a top view of a TCA heart shape diamond showing the original cut facets;

FIG. 11 is a top view of a heart shape diamond of the present invention showing the new facets;

FIG. 12 is a side view of a heart shape diamond of the present invention showing the new facets;

FIG. 13 is a top view of a TCA pear shape diamond showing the original cut facets;

FIG. 14 is a top view of a pear shape diamond of the present invention showing the new facets;

FIG. 15 is a side view of a pear shape diamond of the present invention showing the new facets;

FIG. 16 is a top view of a TCA marquise shape diamond showing the original cut facets;

FIG. 17 is a top view of a marquise diamond of the present invention showing the new facets;

FIG. 18 is a side view of a marquise shape diamond of the present invention showing the new facets;

FIG. 19 is a top view of a TCA princess rectangular shape diamond showing the original cut facets;

FIG. 20 is a top view of a princess rectangular diamond of the present invention showing the new facets;

FIG. 21 is a side view of a princess rectangular shape diamond of the present invention showing the new facets;

FIG. 22 is a top view of a TCA princess square shape diamond showing the original cut facets;

FIG. 23 is a top view of a princess square diamond of the present invention showing the new facets;

FIG. 24 is a side view of a princess square shape diamond of the present invention showing the new facets;

FIG. 25 is a top view of a TCA radiant rectangular shape diamond showing the original cut facets;

FIG. 26 is a top view of a radiant rectangular diamond of the present invention showing the new facets;

FIG. 27 is a side view of a radiant rectangular shape diamond of the present invention showing the new facets;

FIG. 28 is a top view of a TCA radiant square shape diamond showing the original cut facets;

FIG. 29 is a top view of a radiant square diamond of the present invention showing the new facets;

FIG. 30 is a side view of a radiant square shape diamond of the present invention showing the new facets;

FIG. 31 is a top view of a round diamond showing single cut facets and cut in accordance with a second embodiment of the method of the present invention;

FIG. 32 is a top view of the round diamond of FIG. 31 after additional facets are cut;

FIG. 33 is a top view of the round diamond of FIG. 32 after additional facets are cut;

FIG. 34 is a schematic side view of a round diamond of the present invention showing the location of a crown on a diamond;

FIG. 35 is a side view of a ring made with a round diamond of the present invention;

FIG. 36 shows earrings made with round diamonds of the present invention;

FIG. 37 shows a pendant made with a round diamond of the present invention; and

FIG. 38 shows a bracelet made with round diamonds of the present invention.

### DETAILED DESCRIPTION OF THE INVENTION

Here are the differences when one compares the diamond of the present invention to the traditional, conventional and any cut diamond “TCA” which possesses a star facet on the final product (the final product being the completed work as intended to be used by a jeweler to set in a setting).

The following is a preferred process of the present invention for converting a TCA to the new cut, of the present invention.

1) The star facet on most TCA's do not reach and touch the girdle;
2) My new cut pulls the star from the table to the girdle (typical TCA's stop about ½ way from the table to the girdle);
3) Produces larger star facets;
4) Produces larger flashes of light from the larger facet;
5) Changes the angle slightly;
6) Creates a different display of light (allows more in and also lets more out during the return of the light back to the eye;
7) In a preferred process of the present invention, the upper girdle facets and bezel facets change shape and size as a byproduct;
8) The new stars can be 5-sided facets or 3-sided facets depending on the shape of the diamond being cut and the other facets it collides with. Future new cuts could produce more than 5-sided facets as the star makes it way to the girdle depending on how many facets are around the star;
9) Any diamond that posses a star facet that does not touch the girdle is a candidate for my new cut and the preferred process of the present invention.

All the diamonds shown in the drawings can be cut from a rough diamond (rough being defined as diamonds before any cutting to the stone) rather than from already polished diamonds which were cut in traditional manners.

### Methods of Cutting

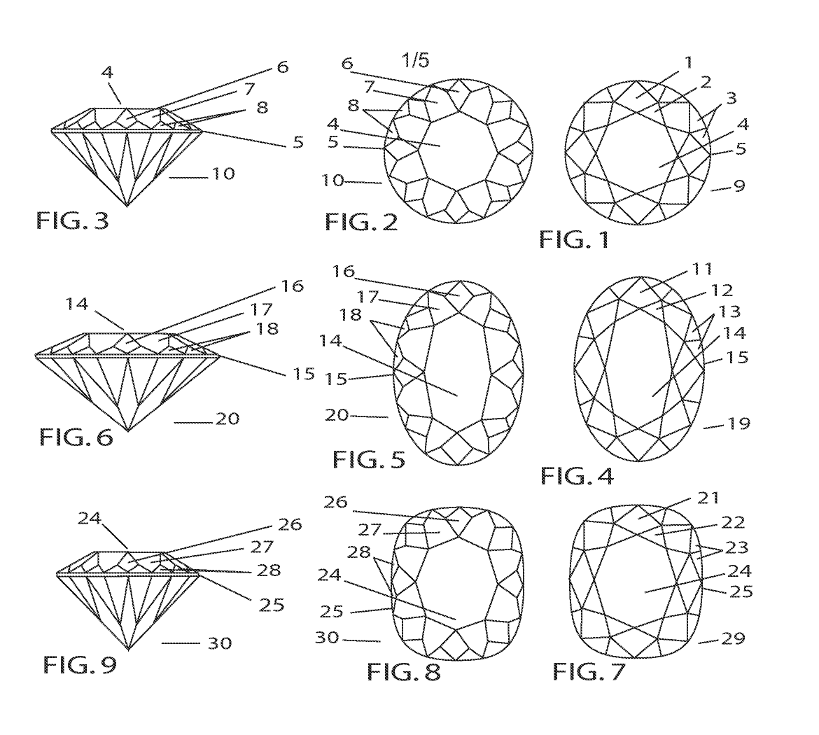

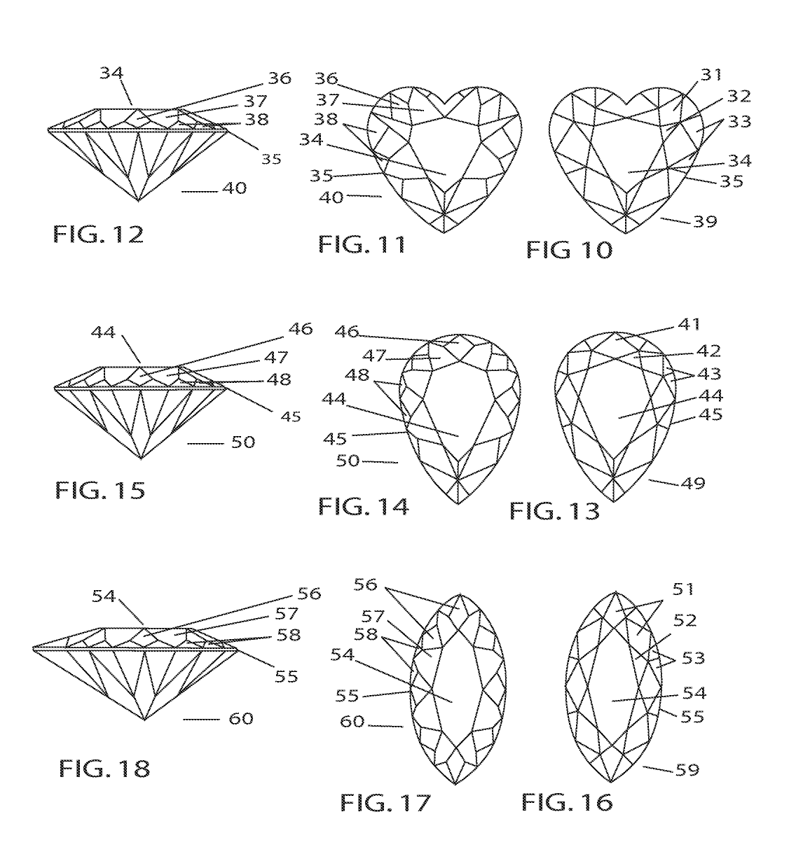

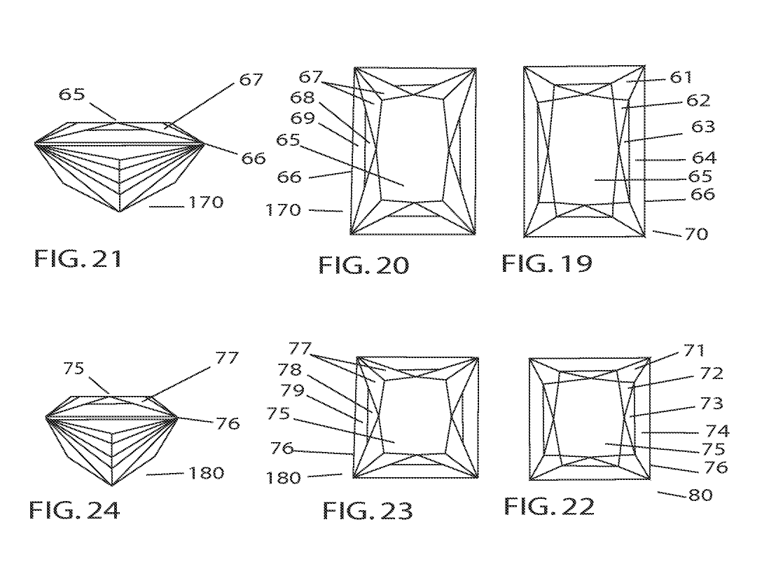

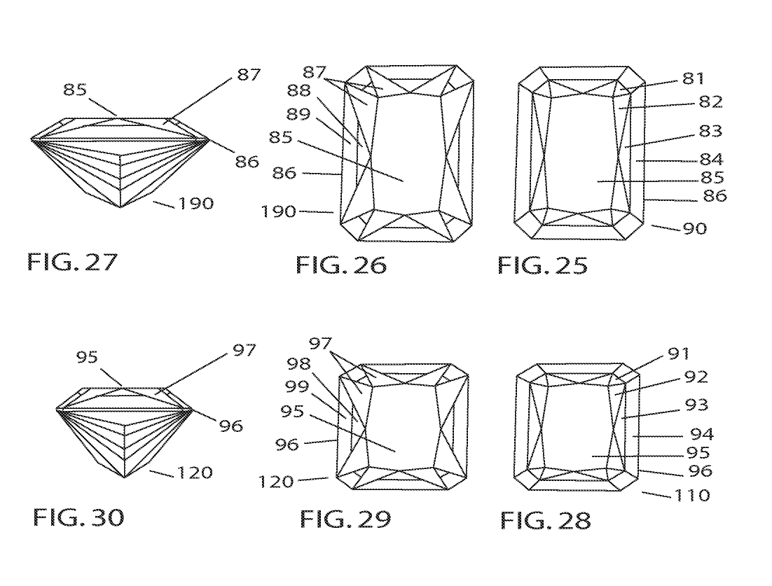

The present inventor contemplates two ways to cut the new diamond facet arrangement of the present invention shown in diamonds 10, 20, 30, 40, 50, 60, 170, 180, 190, 120, 106 in FIGS. 2, 3, 5, 6, 8, 9, 11, 12, 14, 15, 17, 18, 20, 21, 23, 24, 26, 27, 29, 30, and 34. All diamonds 9, 19, 29, 39, 49, 59, 70, 80, 90, 110 that possess a star facet 2 FIG. 1, star facet 12, FIG. 4, star facet 22, FIG. 7, star facet 32, FIG. 10, star facet 42, FIG. 13, star facet 52, FIG. 16, star facet 62, FIG. 19, star facet 72, FIG. 22, star facet 82, FIG. 25 and star facet 92, FIG. 28 (the facet on the top of the diamond that does not touch the girdle) can be recut to make the new diamonds 10, 20, 30, 40, 50, 60, 170, 180, 190, 120, 106 of the present invention. In the new diamond facet arrangement of my invention recutting occurs to the top of the diamond, the crown 102 (see FIG. 34).

### Examples of Rounds

Option 1, cutting from a finished traditional cut diamond 9 to produce a new diamond 10, will produce the new diamond facet arrangement FIG. 2 of my invention by extending the star facet 2, FIG. 1 from the position where it touches the table 4, FIG. 1 and extending it to the girdle 5, FIG. 2. When the star facet 2, FIG. 1 is extended it splits the upper girdle facets 3, FIG. 1 to produce the new upper girdle facet 8, FIG. 2, producing the perfectly symmetrical shaped upper girdle facets 8, FIG. 2. The method of option 1 will lose such little weight that it is perfectly fine to use already finished diamonds. The present inventor believes that the loss is typically only about 1.6 to 1.8%. The ease of option 1 will make it the preferred option. The net loss to the stone from option 1 and option 2 will result in the same loss factor from the rough diamond. In short, it would be difficult to prove that option 1 and 2 differ in net results of loss of weight from rough to a finished product. Because there is essentially no difference in loss of weight, it would generally be better to cut from a traditional diamond pulling the star facet 2, FIG. 1, down to the girdle 5, FIG. 2.

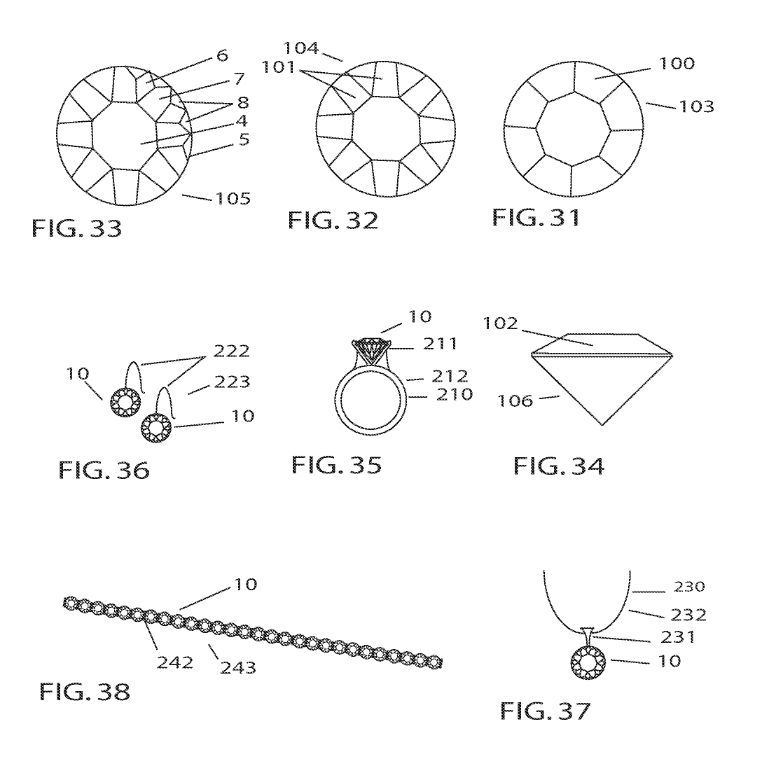

Option 2, cutting from a rough piece of diamond, produces the new diamond facet arrangement of my invention shown in FIG. 2 by first cutting to the typical 8 facet cut top nicknamed “the single cut”, FIG. 31. The 8 facet top single cut facet 100, FIG. 31, is a step in the cutting of a traditional diamond, FIG. 1. From this point the star facet “first cut” 101, FIG. 32 is made by pulling the star facet “first cut” 101, FIG. 32 all the way to the girdle 5, FIG. 33. Afterward the two upper girdle facets 8, FIG. 33 would be made. The disadvantage of this method is that nice symmetry could be compromised and could be considered more difficult, even thought one would possibly save a minor amount of weight. The value of the time wasted in the effort to make the upper girdle facets 8 shown in FIG. 33 symmetrical could outweigh the value of the lost diamond material. Thus the better symmetry may be obtained by cutting the new diamond facet arrangement of my invention shown in FIG. 2 from the finished traditional cut diamond 9 shown in FIG. 1 using option 1. Also, the fact that all diamond cutters are familiar with the method of cutting a traditional cut diamond 9 of FIG. 1 would be considered by most the best way of cutting the new diamond facet arrangement of my invention shown in diamond 10 of FIG. 2.

### Square & Off Square

Pulling the star facets 62, FIG. 19, star facets 72, FIG. 22, star facets 82, FIG. 25, and star facets 92, FIG. 28, of square and off square diamonds produces the new larger star facets 67, FIG. 20, new larger star facets 77, FIG. 23, new larger star facets 87, FIG. 26 and new larger star facets 97, FIG. 29, which also change angles and produces a different look. However the new larger star facets 67, FIG. 20, new larger star facets 77, FIG. 23, new larger Star facets 87, FIG. 26, and new larger Star facets 97, FIG. 29, do not turn themselves into a five-sided facet as shown in star facet 7, FIG. 2, and the fancy shapes star facets 17, FIG. 5, star facets 27, FIG. 8, star facets 37, FIG. 11, star facets 47, FIG. 14, and star facets 57, FIG. 17, even though it does cut through other facets as it makes it way to the girdle 66, 76, 86, and 96 from the star facets 62, FIG. 19, star facets 72, FIG. 22, star facets 82, FIG. 25, and star facets 92, FIG. 28, to the new larger star facets 67, FIG. 20, new larger star facets 77, FIG. 23, new larger star facets 87, FIG. 26, and new larger star facets 97, FIG. 29, and they change the shape and size of the facets as shown in the new larger star facets 67, FIG. 20, new larger star facets 77, FIG. 23, new larger star facets 87, FIG. 26, and new larger star facets 97, FIG. 29. Note the bezel facet 61, FIG. 19, bezel facet 71, FIG. 22, have been cut away completely in the process to produce the new diamond facet arrangement of my invention.

The following is a more detailed description of the method of option 1 performed on a TCA round diamond 9 shown in FIG. 1. In FIG. 2, we take the star facet 2 of diamond 9 and extend its length to the girdle 5 (the outside perimeter) of the diamond 9 to create diamond 10. In doing so, a unique “shield” style facet, shield facet 7 (see FIGS. 2 and 3) is produced. The shield facet 7 becomes larger than it was previously (when it was facet 2). It becomes a five-sided facet when it was three before. The reason it becomes five-sided is because, when the facet 2 is extended it collides with the bezel facet 1 and both upper girdle facets 3 as it extends to the girdle 5. When the new facet 7 collides with the others it produces the new largest facet and makes an exchange of positions of the previous largest facet, bezel 1. This new facet 7 has a different angle from the bezel facet 1. So, the largest facet makes a move and changes the degree to what was there before. Because of the adjustment it appears a little different to the public which is used to the standard cuts. The new cut produces new angles for the largest facet and produces a very appealing display of light performance. Excluding the table, all the facets have a new shape. The new bezel facet 6 is smaller and has a new shape shown in FIGS. 2 and 3. Shield facet 7 is the new largest facet and has five sides when no facet on the original cut diamond 9 had more than four. The upper girdle facets 3 of diamond 9 will become smaller because of the adjustment to star facet 2 which becomes shield facet 7 of new diamond 10, FIGS. 2 and 3. Because the star facet 2 has been extended to the girdle 5, a change to the table 4 does not happen. The adjustment of the star facet 2, produces new facet shapes for all the facets on the top of the new diamond 10 of FIGS. 2 and 3.

As can be seen by looking at FIGS. 2 and 3, facets 7 are five-sided obelisk-shaped facets each communicating with table 4, and each extending to girdle 5. Each obelisk-shaped facet 7 has a base, first and second sides that extend upwardly and inwardly from the base, and third and fourth sides that extend upwardly and inwardly from the first and second sides and meet at a point distal from the base (this point is on girdle 5). The bases of all obelisk-shaped facets 7 touch one another and table 4 and these bases define the periphery of table 4. Facets 7 have no edges within girdle 5.

Diamonds 9 and 10 each include a plurality of lower facets below girdle 5, but preferably these are not altered when practicing the present invention (though they could be). As can be seen in FIG. 2, one side only of each five-sided facet 7 communicates with table 4. In diamond 10 of FIG. 2, there are eight obelisk-shaped facets 7, table 4 is a regular octagon, and each five-sided facet 7 is surrounded by table 4 and four other facets (two facets 6 and two facets 8) that communicate with five-sided facet 7. In diamond 10, each of five-sided facets 7 is about the same size.

In diamonds 20, 40, and 50, some of the five-sided facets 17, 37, and 47, are larger than others of the five-sided facets.

In diamond 20 (FIG. 5), table 14 is oblong in shape.

In diamond 10 (FIG. 2), table 4 is a symmetrical polygon (an octagon), and girdle 5 tracks a circle.

In diamond 20 (FIG. 5), girdle 15 tracks an oval. In diamond 40 (FIG. 11), girdle 35 tracks a heart. In diamond 60 (FIG. 17), girdle 55 tracks a cat eye shape. In diamond 50 (FIG. 14), girdle 45 tracks a teardrop shape.

Radiant square diamond 120, shown in FIGS. 29 and 30, comprises a radiant square diamond body having a girdle 96 defining a periphery, a table 95 and a plurality of upper facets 97, 98, 99 above girdle 96, the upper facets including a plurality of elongated facets 97 each communicating with table 95, and each extending to girdle 96. Each elongated facet 97 has a base in contact with table 95, and first and second sides that extend upwardly and inwardly from the base and meet at a point distal from the base (this point is on girdle 96). Girdle 96 has eight corners, and the point of each elongated facet 97 extends to a corner of the girdle 96.

Advantageously, the diamonds of the present invention can be incorporated into jewelry, such as ring 210 (FIG. 35), earrings 223 (FIG. 36), pendant or necklace 230 (FIG. 37), and bracelet 242 (FIG. 38).

Ring 210 (FIG. 35) is shown with around diamond 10 of the present invention, though other shapes could be used. Ring 210 includes a shank 212 and a head 211 for diamond 10.

Earrings 223 (FIG. 36) are shown with round diamonds 10 of the present invention, though other shapes could be used. Earrings 223 include earring wires 222.

Pendant or necklace 230 (FIG. 37) includes a chain 232 and a bail 231 for diamond 10. Other shapes of diamonds of the present invention could be used instead.

Bracelet 242 (FIG. 38) includes settings 243 for multiple diamonds of the present invention. Shown in FIG. 38 are round diamonds 10, though other shapes of diamonds of the present invention could be used instead. or in addition.

### PARTS LIST

The following is a list of parts and materials suitable for use in the present invention:

| Part | |
|---|---|
| Number | Description |
| 1 | bezel facet |
| 2 | star facet |
| 3 | upper girdle facets |
| 4 | table |
| 5 | girdle |
| 6 | new bezel facet |
| 7 | new star “shield” facet |
| 8 | upper girdle facets |
| 9 | TCA round diamond |
| 10 | new round diamond of the present invention |
| 11 | bezel facet |
| 12 | star facet |
| 13 | upper girdle facets |
| 14 | table |
| 15 | girdle |
| 16 | new bezel facet |
| 17 | new star “shield” facet |
| 18 | upper girdle facets |
| 19 | TCA oval diamond |
| 20 | new oval diamond of the present invention |
| 21 | bezel facet |
| 22 | star facet |
| 23 | upper girdle facets |
| 24 | table |
| 25 | girdle |
| 26 | new bezel facet |
| 27 | new star “shield” facet |
| 28 | upper girdle facets |
| 29 | TCA cushion diamond |
| 30 | new cushion diamond of the present invention |
| 31 | bezel facet |
| 32 | star facet |
| 33 | upper girdle facets |
| 34 | table |
| 35 | girdle |
| 36 | new bezel facet |
| 37 | new star “shield” facet |
| 38 | upper girdle facets |
| 39 | TCA heart shape diamond |
| 40 | new heart shape diamond of the present invention |
| 41 | bezel facet |
| 42 | star facet |
| 43 | upper girdle facets |
| 44 | table |
| 45 | girdle |
| 46 | new bezel facet |
| 47 | new star “shield” facet |
| 48 | upper girdle facets |
| 49 | TCA pear shape diamond |
| 50 | new pear shape diamond of the present invention |
| 51 | bezel facet |
| 52 | star facet |
| 53 | upper girdle facets |
| 54 | table |
| 55 | girdle |
| 56 | new bezel facet |
| 57 | new star “shield” facet |
| 58 | upper girdle facets |
| 59 | TCA marquise shape diamond |
| 60 | new marquise shape diamond of the present invention |
| 61 | bezel facet |
| 62 | star facet |
| 63 | table bezel facets |
| 64 | girdle bezel facet |
| 65 | table |
| 66 | girdle |
| 67 | new star facet |
| 68 | new table bezel facets |
| 69 | new girdle bezel facets |
| 70 | TCA princess rectangular shape diamond |
| 170 | new princess rectangular shape diamond of the present invention |
| 71 | bezel facet |
| 72 | star facet |
| 73 | table bezel facets |
| 74 | girdle bezel facet |
| 75 | table |
| 76 | girdle |
| 77 | new star facet |
| 78 | new table bezel facets |
| 79 | new girdle bezel facets |
| 80 | TCA princess square diamond |
| 180 | new princess square diamond of the present invention |
| 81 | bezel facet |
| 82 | star facet |
| 83 | table bezel facets |
| 84 | girdle bezel facet |
| 85 | table |
| 86 | girdle |
| 87 | new star facet |
| 88 | new table bezel facets |
| 89 | new girdle bezel facets |
| 90 | TCA radiant rectangular diamond |
| 190 | new radiant rectangular diamond of the present invention |
| 91 | bezel facet |
| 92 | star facet |
| 93 | table bezel facets |
| 94 | girdle bezel facet |
| 95 | table |
| 96 | girdle |
| 97 | new star facet |
| 98 | new table bezel facets |
| 99 | new girdle bezel facets |
| 100 | single-cut facets |
| 101 | “first cut” star facet |
| 102 | crown |
| 103 | round diamond with single-cut facets 100 |
| 104 | round diamond with “first cut” star facets 101 |
| 105 | round diamond with some “first cut” star facets 101 and some new |
| | bezel facets 6 and some new star shield facets 7 and some upper girdle |
| | facets 8 |
| 106 | round diamond of the present invention cut from rough |
| 110 | TCA a radiant square diamond |
| 120 | new a radiant square diamond of the present invention |
| 210 | ring |
| 211 | head for diamond 10 of ring 210 |
| 212 | shank of ring 210 |
| 222 | earring wires of earrings 223 |
| 223 | earrings |
| 230 | pendant or necklace |
| 231 | bail for diamond 10 of pendant 230 |
| 232 | chain of necklace or pendant 230 |
| | (a closed loop-only partly shown in FIG. 37) |
| 242 | bracelet having clasp at each end |
| 243 | setting for diamond 10 of bracelet 242 |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A cut diamond, comprising:
a) a diamond body having a girdle defining a periphery; and
b) a table and a plurality of upper facets above the girdle,
the upper facets including a plurality of five-sided obelisk-shaped facets each communicating with the table, and each extending to the girdle,
wherein each obelisk-shaped facet has a base, first and second sides that extend upwardly and inwardly from the base, and third and fourth sides that extend upwardly and inwardly from the first and second sides and meet at a point distal from the base, and
the bases of all obelisk-shaped facets touch and define the periphery of the table.

2. (canceled)

3. The cut diamond of claim 1 wherein one side only of each five-sided facet communicates with the table.

4-16. (canceled)

17. A re-cut diamond, comprising:
an initially cut diamond body that was cut from an uncut diamond using initial cuts, the body having a girdle defining a periphery;
the body having a table and a plurality of upper facets above the girdle defined by initial cuts;
the upper facets including a plurality of five-sided facets that are facets re-cut from the initially cut diamond body, each five-sided facet bordered by a periphery of five edges and wherein there are no edges within the girdle, and
wherein each five-sided facet extends from the table to the girdle.

18. (canceled)

19. The re-cut diamond of claim 17 wherein one side only of each five-sided facet communicates with the table.

20-32. (canceled)

33. A method of re-cutting a diamond, comprising the steps of:
providing an existing cut diamond having a diamond body with a girdle defining a periphery, a table and a plurality of upper facets above the girdle, the upper facets including star facets and bezel facets;
cutting the existing diamond to extend at least some of the star facets from the table to the girdle.

34. The method of claim 33 wherein the diamond is a round shape or a fancy shape, and at least some of the star facets are converted to five-sided facets.

35. The method of claim 33 wherein the diamond is a square shape or an off-square shape, and at least some of the star facets are converted to five-sided facets.

36. The method of claim 33 wherein at least some of the star facets are converted from a star facet which touches the table but not the girdle to a larger three-sided or five-sided facet which reaches from the table to the girdle

37. (canceled)

38. The method of claim 33 wherein each five-sided facet has a base, first and second sides that extend upwardly and inwardly from the base, and third and fourth sides that extend upwardly and inwardly from the first and second sides and meet at a point above the base.

39. (canceled)

40. The method of claim 33 wherein the existing diamond is cut to the girdle so that each five-sided facet extends to the girdle.

41. The method of claim 33 wherein the upper facets include a plurality of star facets and wherein each star facet is extended to a position next to the girdle.

42. (canceled)

43. The method of claim 33 wherein the existing cut diamond is one which was cut at least six months before being re-cut.

44-46. (canceled)

47. A cut diamond, made by the method of claim 33.

48. A cut diamond, comprising:
a square or off-square diamond body having a girdle defining a periphery; and
a table and a plurality of upper facets above the girdle,
the upper facets including a plurality of elongated facets each communicating with the table, and each extending to the girdle,
wherein each elongated facet has a base, first and second sides that extend upwardly and inwardly from the base and meet at a point distal from the base, and
the bases of all elongated facets touch the periphery of the table.

49. The cut diamond of claim 48, wherein the girdle has multiple corners, and the point of each elongated facet extends to a corner of the girdle.

50. A piece of including the cut diamond of claim 1.

51. The piece of jewelry of claim 50, wherein the jewelry is a ring.

52. The piece of jewelry of claim 50, wherein the jewelry is a bracelet.

53. The piece of jewelry of claim 50, wherein the jewelry includes an earring.

54. The piece of jewelry of claim 50, wherein the jewelry is a necklace.

55. (canceled)
